(19) United States
(12) Patent Application Publication
(10) Pub. No.: US 2013/0099164 A1
(43) Pub. Date: Apr. 25, 2013

(54) USE OF A PRESSURIZED CERAMIC HEAT EXCHANGER AS AN INTEGRAL PART OF A PLANT FOR CONVERTING SILICON TETRACHLORIDE TO TRICHLOROSILANE

(71) Applicants: Guido Stochniol, Haltern am See (DE); Yuecel Oenal, Carl Junction, MO (US); Alfons Bieker, Wehr (DE); Ingo Pauli, Schmitten (DE); Ingrid Lunt-Rieg, Bad Homburg (DE)

(72) Inventors: Guido Stochniol, Haltern am See (DE); Yuecel Oenal, Carl Junction, MO (US); Alfons Bieker, Wehr (DE); Ingo Pauli, Schmitten (DE); Ingrid Lunt-Rieg, Bad Homburg (DE)

(73) Assignee: Evonik Degussa GmbH, Essen (DE)

(21) Appl. No.: 13/521,949

(22) PCT Filed: Dec. 16, 2010
(86) PCT No.: PCT/EP2010/069909

§ 371 Date: Jan. 4, 2013

(30) Foreign Application Priority Data
Jan. 18, 2010 (DE) 10 2010 000 979.2

(51) Int. Cl. C01B 33/107

(52) U.S. Cl. CPC C01B 33/1071
USPC 252/372

(57) ABSTRACT

The invention relates to the use of a ceramic heat exchanger as an integral part of a process for catalytic dehalogenation of silicon tetrachloride to trichlorosilane in the presence of hydrogen, wherein the product gas and the reactant gases are conducted as pressurized streams through the heat exchanger, and the heat exchanger comprises heat exchanger elements made from ceramic material.

The invention relates to the use of a ceramic heat exchanger as an integral part of a process for catalytic hydrodehalogenation of silicon tetrachloride (SiCl₄) to trichlorosilane (HSiCl₃) in the presence of hydrogen.

In many industrial processes in silicon chemistry, SiCl₄ and HSiCl₃ form together. It is therefore necessary to interconvert these two products and hence to satisfy the particular demand for one of the products.

Furthermore, high-purity HSiCl₃ is an important feedstock in the production of solar silicon.

In the hydrodechlorination of silicon tetrachloride (STC) to trichlorosilane (TCS), the industrial standard is the use of a thermally controlled process in which the STC is passed together with hydrogen into a graphite-lined reactor, known as the “Siemens furnace”. The graphite rods present in the reactor are operated in the form of resistance heating, such that temperatures of 1100° C. and higher are attained. By virtue of the high temperature and the hydrogen component, the equilibrium position is shifted toward the TCS product. The product mixture is conducted out of the reactor after the reaction and removed in complex processes. The flow through the reactor is continuous, and the inner surfaces of the reactor must consist of graphite, being a corrosion-resistant material. For stabilization, an outer metal shell is used. The outer wall of the reactor has to be cooled in order to very substantially suppress the decomposition reactions which occur at high temperatures at the hot reactor wall, and which can lead to silicon deposits.

In addition to the disadvantageous decomposition owing to the necessary and uneconomic very high temperature, the regular cleaning of the reactor is also disadvantageous. Owing to the restricted reactor size, a series of independent reactors has to be operated, which is likewise economically disadvantageous. The present technology does not allow operation under pressure in order to achieve a higher space-time yield, in order thus, for example, to reduce the number of reactors.

A further disadvantage is the performance of a purely thermal reaction without a catalyst, which makes the process very inefficient overall.

A process described elsewhere envisages that the chemical conversion to prepare trichlorosilane from silicon tetrachloride and hydrogen is carried out in a pressurized reactor. By virtue of this, and by virtue of further design and process technology measures, it is possible to describe a process in which high space-time yields of TCS are obtained with a high selectivity.

However, a problem here is that the reaction is an equilibrium reaction which is preferably conducted to the product side by means of a high temperature, such that a reverse reaction is possible in the cool regions outside the reaction zone.

The product mixture obtained in the reaction, i.e. the product stream, can advantageously be conducted through at least one heat exchanger upstream of the reaction before any further workup, in order to preheat the silicon tetrachloride and/or hydrogen reactants in an energy-saving manner while cooling the product stream. Heat exchangers used to date in such processes are operated under ambient pressure, i.e. there is a lowering of the pressure level from the reactor to the heat exchanger. For instance, DE 2005 005044 describes ceramic heat exchangers which work in an ambient pressure state.

It would thus be advantageous if such a lowering of the pressure level were unnecessary, such that the cooling of the reaction mixture could be performed under pressure with simultaneous preheating of the reactant gas streams used.

It was thus an object of the present invention to provide a process with which silicon tetrachloride can be converted to trichlorosilane, with avoidance of a lowering of the pressure level in the course of the process and nevertheless allowing the energy of the heated product gas to be used to preheat the reactants.

This object is achieved by the process described hereinafter.

More particularly, the invention provides a process in which a silicon tetrachloride-containing reactant gas and a hydrogen-containing reactant gas are reacted in a hydrodechlorination reactor by supplying heat to form a pressurized trichlorosilane-containing and HCl-containing product gas, the product gas being cooled by means of a heat exchanger and the silicon tetrachloride-containing reactant gas conducted through the same heat exchanger and/or the hydrogen-containing reactant gas being heated, characterized in that the product gas and the silicon tetrachloride-containing reactant gas and/or the hydrogen-containing reactant gas are conducted as pressurized streams through the heat exchanger, and the heat exchanger comprises heat exchanger elements made from ceramic material. In the product stream, it is optionally also possible for by-products such as dichlorosilane, mono-chlorosilane and/or silane to be present. The product stream generally also contains unconverted reactants, i.e. silicon tetrachloride and hydrogen.

The equilibrium reaction in the hydrodechlorination reactor is typically performed at 700° C. to 1000° C., preferably 850° C. to 950° C., and at a pressure in the range from 1 to 10 bar, preferably from 3 to 8 bar, more preferably from 4 to 6 bar.

The ceramic material for the heat exchanger elements is preferably selected from Al₂O₃, AlN, Si₃N₄, SiCN and SiC, more preferably selected from Si-infiltrated SiC, isostatically pressed SiC, hot isostatically pressed SiC or SiC sintered at ambient pressure (SSiC).

In all variants described for the process according to the invention, the silicon tetrachloride-containing reactant gas and the hydrogen-containing reactant gas can also be conducted through the heat exchanger as a combined stream.

The pressure differences in the heat exchanger between the different streams should not be more than 10 bar, preferably not more than 5 bar, more preferably not more than 1 bar, especially preferably not more than 0.2 bar, measured at the inlets and outlets of the product gas and reactant gas streams.

In addition, the pressure of the product stream at the inlet of the heat exchanger should not be more than 2 bar below the pressure of the product stream at the outlet of the hydrodechlorination reactor, and the pressures of the product stream at the inlet of the heat exchanger and at the outlet of the hydrodechlorination reactor should preferably be the same. The pressure at the outlet of the hydrodechlorination reactor is typically in the range from 1 to 10 bar, preferably in the range from 4 to 6 bar.

The pressures in the heat exchanger should be within the range from 1 to 10 bar, preferably within the range from 3 to 8 bar, more preferably within the range from 4 to 6 bar, measured at the inlets and outlets of the product gas and reactant gas streams.

In all variants of the process according to the invention, the heat exchanger is preferably a tube bundle heat exchanger.

The silicon tetrachloride-containing reactant gas conducted through the heat exchanger and/or the hydrogen-containing reactant gas is/are preferably preheated in the heat exchanger to a temperature in the range from 150° C. to 900° C., preferably 300° C. to 800° C., more preferably 500° C. to 700° C. The product gas conducted through the heat exchanger is typically cooled to a temperature in the range from 900° C. to 150° C., preferably 800° C. to 300° C., more preferably 700° C. to 500° C.

Thus, in the process according to the invention, the heat exchanger is advantageously operated at a pressure of 1 to 10 bar, preferably of 3 to 8 bar, more preferably at 4 to 6 bar, the pressure difference in the heat exchanger between the streams being generally not more than 10 bar, preferably not more than 5 bar, more preferably not more than 1 bar and especially not more than 0.2 bar.

The invention also provides for the use of a heat exchanger as an integral part of a plant for converting silicon tetrachloride to trichlorosilane, characterized in that a trichlorosilane-containing and HCl-containing product gas and a silicon tetrachloride-containing reactant gas and/or a hydrogen-containing reactant gas are conducted as pressurized streams through the heat exchanger, and the heat exchanger comprises heat exchanger elements made from ceramic material. In this case, the heat exchanger used in accordance with the invention may be as described above in connection with the process according to the invention, for example in relation to the ceramic material for the heat exchanger elements, the pressures in the heat exchanger during operation and.

The heat exchanger used is preferably a plate heat exchanger or a tube bundle heat exchanger, with the plates having channels or capillaries arranged in stacks. The arrangement of the plates is preferably configured such that only product gas flows in one portion of the capillaries or channels, and only reactant gas flows in other parts. Mixing of the gas streams must be avoided. The different gas streams can be conducted in countercurrent or else in cocurrent. The construction of the heat exchanger is selected such that the energy released with the cooling of the product gas simultaneously serves to conduct the reactant gases out. The capillaries may also be arranged in the form of a tube bundle heat exchanger. In this case, a gas stream flows through the tubes (capillaries), while the other gas stream flows around the tubes.

Irrespective of which type of heat exchanger is selected, heat exchangers which fulfil at least one, preferably more than one, of the following construction features are particularly preferred: the hydraulic diameter (DH) of the channels or of the capillaries, defined as four times the cross-sectional area divided by circumference, is less than 5 mm, preferably less than 3 mm. The ratio of exchange area to volume is greater than 400 m⁻¹; the heat transfer coefficient is greater than 300 watts per metre²×K.

The heat exchanger may be arranged directly adjoining the reactor, but it may also be connected to the reactor via lines. In that case, the lines are preferably thermally insulated.

The figures which follow serve to illustrate the above-described variants of the invention and possible uses of the heat exchanger.

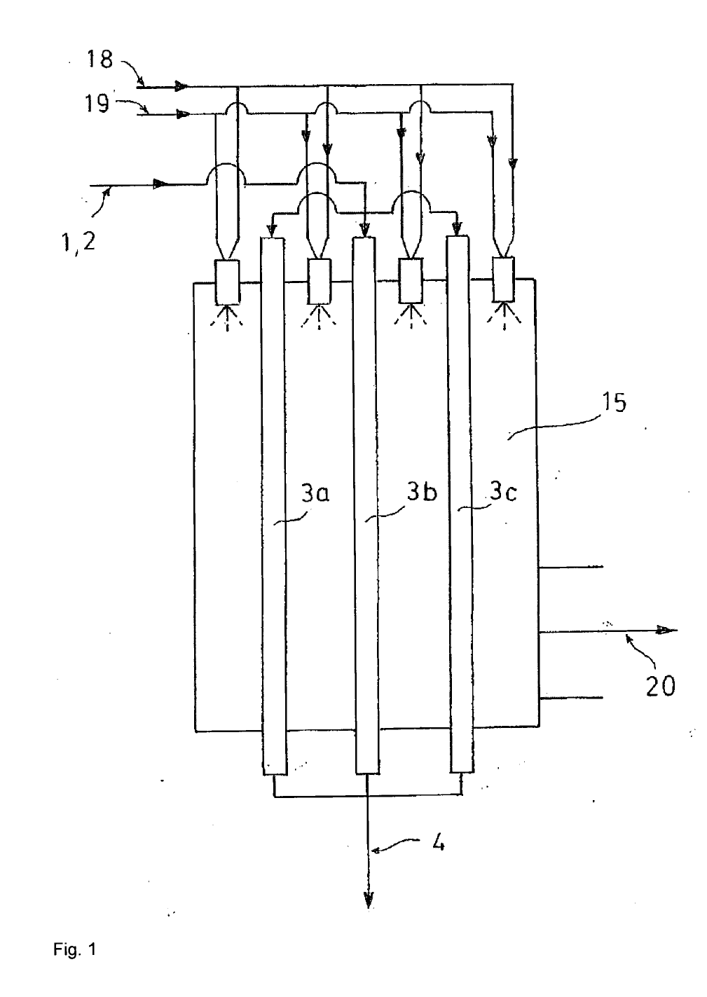

FIG. 1 shows, illustratively and schematically, a hydrodechlorination reactor which, together with the heat exchanger used in accordance with the invention, may be part of a plant for reacting silicon tetrachloride with hydrogen to give trichlorosilane.

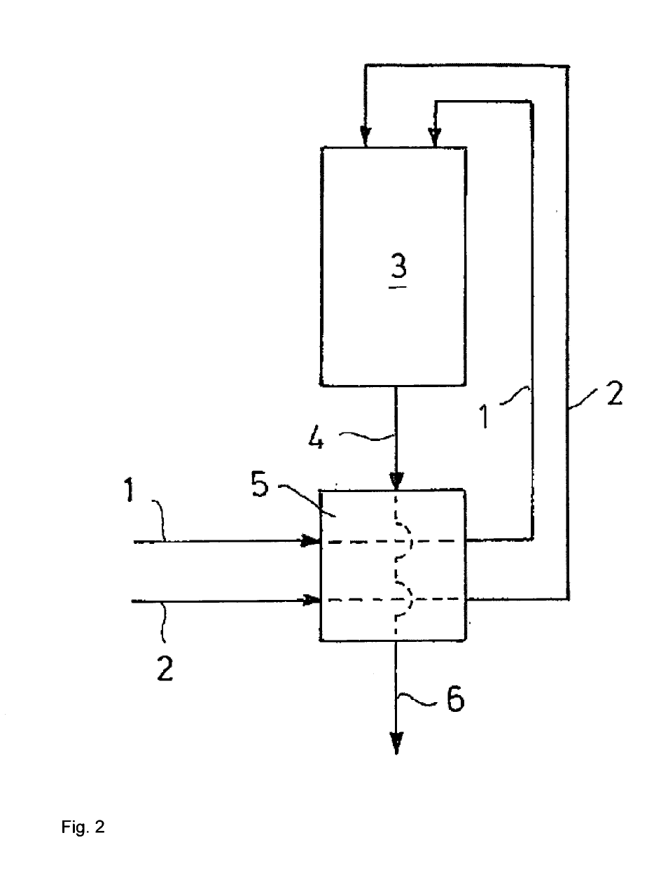

FIG. 2 shows, schematically, the passage of two reactant streams (to be preheated) through a heat exchanger and the passage of a product stream (to be cooled) coming from a reactor.

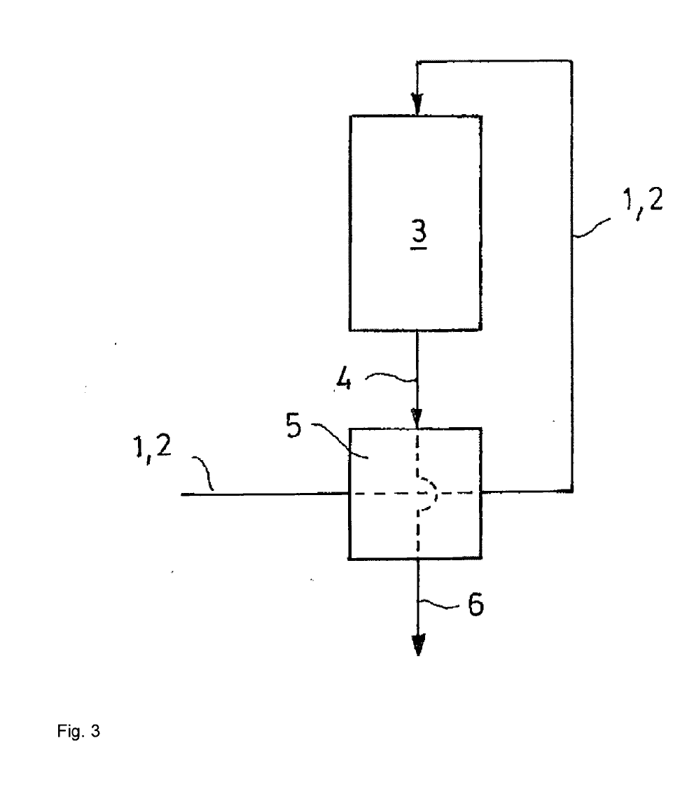

FIG. 3 shows, schematically, the passage of a combined reactant stream (to be preheated) through a heat exchanger and the passage of a product stream (to be cooled) coming from a reactor.

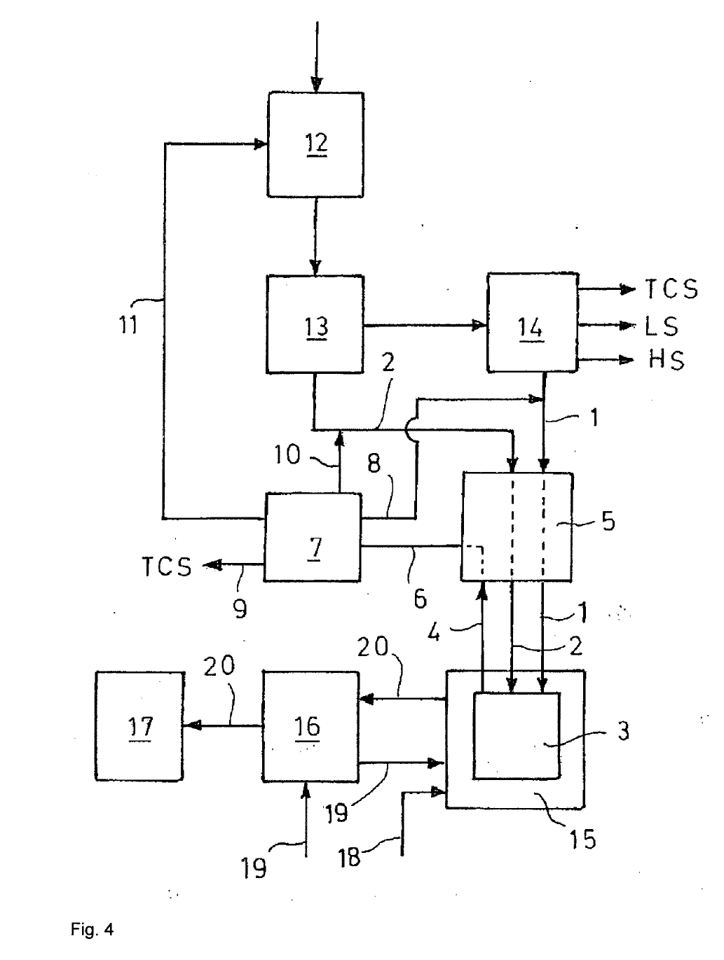

FIG. 4 shows, illustratively and schematically, a plant for preparing trichlorosilane from metallurgical silicon, in which the inventive heat exchanger can be used.

The hydrodechlorination reactor shown in FIG. 1 comprises a plurality of reactor tubes 3a, 3b, 3c arranged in a combustion chamber 15, a combined reactant gas 1,2 which is conducted into the plurality of reactor tubes 3a, 3b, 3c, and a line 4 for a product stream conducted out of the plurality of reactor tubes 3a, 3b,3c. The reactor shown also includes a combustion chamber 15 and a line for combustion gas 18 and a line for combustion air 19, which lead to the four burners shown in the combustion chamber 15. Also shown, finally, is a line for flue gas 20 which leads out of the combustion chamber 15.

FIG. 2 shows a product stream 4 coming out of a reactor 3, which is conducted into a heat exchanger 5 and conducted out as a (cooled) product stream 6, and two reactant streams 1 and 2 which are conducted through the same heat exchanger 5 and (having then been preheated), after leaving the heat exchanger 5, are conducted into the reactor 3.

FIG. 3 shows a product stream 4 which comes out of a reactor 3 and is conducted into a heat exchanger 5 and conducted out as a (cooled) product stream 6, and a combined reactant stream 1,2 which is conducted through the same heat exchanger 5 and (having then been preheated), after leaving the heat exchanger 5, is conducted into the reactor 3.

The plant shown in FIG. 4 comprises a hydrodechlorination reactor 3 arranged in a combustion chamber 15, a line 1 for silicon tetrachloride-containing gas and a line 2 for hydrogen-containing gas, both of which lead into the hydrodechlorination reactor 3, a line 4 for a trichlorosilane-containing and HCl-containing product gas which is conducted out of the hydrodechlorination reactor 3, and the inventive heat exchanger 5, through which the product gas line 4 and the silicon tetrachloride line 1 and the hydrogen line 2 are conducted, such that heat transfer from the product gas line 4 into the silicon tetrachloride line 1 and into the hydrogen line 2 is possible. The plant further comprises a plant component 7 for removal of silicon tetrachloride 8, of trichlorosilane 9, of hydrogen 10 and of HCl 11. This involves conducting the silicon tetrachloride removed through the line 8 into the silicon tetrachloride line 1, feeding the trichlorosilane removed through the line 9 to an end product removal step, conducting the hydrogen removed through the line 10 into the hydrogen line 2 and feeding the HCl removed through the line 11 to a plant 12 for hydrochlorinating silicon. The plant further comprises a condenser 13 for removing the hydrogen coproduct which originates from the reaction in the hydrochlorination plant 12, this hydrogen being conducted through the hydrogen line 2 via the heat exchanger 5 into the hydrodechlorination reactor 3. Also shown is a distillation system 14 for removing silicon tetrachloride 1 and trichlorosilane (TCS), and also low boilers (LS) and high boilers (HS) from the product mixture, which comes from the hydro-dechlorination plant 12 via the condenser 13. The plant finally also comprises a recuperator 16 which preheats the combustion air 19 intended for the combustion chamber 15 with the flue gas 20 flowing out of the combustion chamber 15, and a plant 17 for raising steam with the aid of the flue gas 20 flowing out of the recuperator 16.

### LIST OF REFERENCE NUMERALS

(1) silicon tetrachloride-containing reactant gas
(2) hydrogen-containing reactant gas
(1,2) combined reactant gas
(3) hydrodechlorination reactor
(3a, 3b, 3c) reactor tubes
(4) product stream
(5) heat exchanger
(6) cooled product stream
(7) downstream plant component
(7a, 7b, 7c) arrangement of several plant components
(8) silicon tetrachloride stream removed in (7) or (7a, 7b, 7c)
(9) end product stream removed in (7) or (7a, 7b, 7c)
(10) hydrogen stream removed in (7) or (7a, 7b, 7c)
(11) HCl stream removed in (7) or (7a, 7b, 7c)
(12) upstream hydrodechlorination process or plant
(13) condenser
(14) distillation plant
(15) heating space or combustion chamber
(16) recuperator
(17) plant for raising steam
(18) combustion gas
(19) combustion air
(20) flue gas

1. A process comprising:
reacting a silicon tetrachloride-comprising reactant gas and a hydrogen-comprising reactant gas in a hydrodechlorination reactor by supplying heat, to obtain a pressurized product gas comprising trichlorosilane and HCl,
cooling the pressurized product gas by means of a heat exchanger, and heating (i) the silicon tetrachloride-comprising reactant gas, (ii) the hydrogen-comprising reactant gas, or both (i) and (ii), by means of the heat exchanger,
wherein
the pressurized product gas and (i) the silicon tetrachloride-comprising reactant gas, (ii) hydrogen-comprising reactant gas, or both (i) and (ii), pass as pressurized streams through the heat exchanger, and the heat exchanger comprises a ceramic material.

2. The process of claim 1, wherein the ceramic material is selected from the group consisting of Al₂O₃, AlN, Si₃N₄, SiCN and SiC.

3. The process of claim 1, wherein the ceramic material is selected from the group consisting of Si-infiltrated SiC, isostatically pressed SiC, isostatically hot-pressed SiC, and SiC sintered at ambient pressure (SSiC).

4. The process of claim 1, wherein the silicon tetrachloride-comprising reactant gas and the hydrogen-comprising reactant gas pass through the heat exchanger in a combined stream.

5. The process of claim 1, wherein a pressure difference between different streams in the heat exchanger is not more than 10 bar, measured at an inlet and outlet of the pressurized product gas and reactant gas streams.

6. The process of claim 1, wherein a pressure of the pressurized product gas stream at an inlet of the heat exchanger is not more than 2 bar below a pressure of the pressurized product gas stream at an outlet of the hydrodechlorination reactor.

7. The process of claim 1, wherein pressures in the heat exchanger are 1 to 10 bar, measured at inlets and outlets of the pressurized product gas and reactant gas streams.

8. The process of claim 1, wherein the heat exchanger is a tube bundle heat exchanger.

9. The process of claim 1, wherein (i) the silicon tetrachloride-comprising reactant gas, (ii) the hydrogen-comprising reactant gas, or both (i) and (ii), are heated by the heat exchanger to a temperature of 150° C. to 900° C.

10. The process of claim 1, wherein the pressurized product gas is cooled by the heat exchanger to a temperature of 900° C. to 150° C.

11. The process of claim 1, wherein the heat exchanger is operated at a pressure of 1 to 10 bar.

12-18. (canceled)

19. The process of claim 1, wherein a pressure difference between different streams in the heat exchanger is not more than 1 bar, measured at an inlet and outlet of the pressurized product gas and reactant gas streams.

20. The process of claim 1, wherein a pressure difference between different streams in the heat exchanger is not more than 0.2 bar, measured at an inlet and outlet of the pressurized product gas and reactant gas streams.

21. The process of claim 1, wherein pressures in the heat exchanger are 3 to 8 bar, measured at inlets and outlets of the pressurized product gas and reactant gas streams.

22. The process of claim 1, wherein pressures in the heat exchanger are 4 to 6 bar, measured at inlets and outlets of the pressurized product gas and reactant gas streams.

23. The process of claim 1, wherein (i) the silicon tetrachloride-comprising reactant gas, (ii) the hydrogen-comprising reactant gas, or both (i) and (ii), are heated by the heat exchanger to a temperature of 300° C. to 800° C.

24. The process of claim 1, wherein (i) the silicon tetrachloride-comprising reactant gas, (ii) the hydrogen-comprising reactant gas, or both (i) and (ii), are heated by the heat exchanger to a temperature of 500° C. to 700° C.

25. The process of claim 1, wherein the pressurized product gas is cooled by the heat exchanger to a temperature of 800° C. to 300° C.

26. The process of claim 1, wherein the pressurized product gas is cooled by the heat exchanger to a temperature of 700° C. to 500° C.

27. The process of claim 1, wherein the heat exchanger is operated at a pressure of 4 to 6 bar.
